(19) United States
(12) Patent Application Publication
(10) Pub. No.: US 2024/0393542 A1
(43) Pub. Date: Nov. 28, 2024

(54) OPTICAL CONNECTOR

(71) Applicant: MITSUBISHI HEAVY INDUSTRIES, LTD., Tokyo (JP)

(72) Inventors: Saneyuki Goya, Tokyo (JP); Yasuyuki Fujiya, Tokyo (JP); Takeshi Satake, Kyoto (JP); Masaaki Taniguchi, Kyoto (JP)

(73) Assignee: MITSUBISHI HEAVY INDUSTRIES, LTD., Tokyo (JP)

(21) Appl. No.: 18/697,309

(22) PCT Filed: Sep. 28, 2022
(86) PCT No.: PCT/JP2022/036155

§ 371 Date: Mar. 29, 2024

(30) Foreign Application Priority Data
Oct. 1, 2021 (JP) 2021-162871

(51) Int. Cl. G02B 6/36; G02B 6/12; G02B 6/26

(52) U.S. Cl. CPC G02B 6/3632; G02B 6/12; G02B 6/264; G02B 2006/12121; G02B 2006/12135

(57) ABSTRACT

An optical connector includes: an optical fiber arranged along an optical axis; a light guide member having a first end face and a second end face and configured to guide a laser beam from the first end face to the second end face, the laser beam emitted along the optical axis from a light source entering the first end face, and the second end face being joined to an incident end face of the optical fiber; and a window member arranged between the light source and the light guide member and configured to guide, to the first end face of the light guide member, the laser beam emitted from the light source. The window member has a first transmission face and a second transmission face, the laser beam emitted from the light source entering the first transmission face, and the second transmission face being configured to emit the laser beam.

### TECHNICAL FIELD

The present disclosure relates to an optical connector.

### BACKGROUND ART

Optical connectors to guide a laser beam emitted from a light source to an optical fiber are conventionally known (for example, see Patent Literature 1). The optical connector disclosed in Patent Literature 1 guides a light beam that has entered a window to a light guide rod via a light guide space and then guides the light beam to an incident end face of an optical fiber through a light guide path of the light guide rod. In Patent Literature 1, the end face of the window that a light beam enters is arranged along a plane orthogonal to the optical axis of the light beam.

### CITATION LIST

### Patent Literature

### [PTL 1]

Japanese Patent Application Laid-Open No. H7-209554

### SUMMARY OF INVENTION

### Technical Problem

When the end face of a window that a light beam enters is arranged along a plane orthogonal to the optical axis of the light beam, however, a part of the light beam is reflected and guided back to a light source, and this may cause damage to a laser oscillator or an optical fiber of the light source.

The present disclosure has been made in view of such circumstances and intends to provide an optical connector that can prevent damage from occurring in a laser oscillator or an optical fiber of a light source of a laser beam.

### Solution to Problem

An optical connector according to one aspect of the present disclosure includes: an optical fiber arranged along an axis; a light guide member having a first end face and a second end face and configured to guide a laser beam from the first end face to the second end face, the laser beam emitted along the axis from a light source entering the first end face, and the second end face being joined to an incident end face of the optical fiber; and a window member arranged between the light source and the light guide member and configured to guide, to the first end face of the light guide member, the laser beam emitted from the light source. The window member has a first transmission face and a second transmission face, the laser beam emitted from the light source entering the first transmission face, and the second transmission face being configured to emit the laser beam entering the first transmission face to the light guide member, and the first transmission face is arranged inclined by a predetermined angle relative to a plane orthogonal to the axis.

### Advantageous Effects of Invention

According to the present disclosure, an optical connector that can prevent damage from occurring in a laser oscillator or an optical fiber of a light source of a laser beam can be provided.

### BRIEF DESCRIPTION OF DRAWINGS

FIG. 1 is a longitudinal sectional view illustrating an optical connector according to a first embodiment of the present disclosure.

FIG. 2 is a partial enlarged view of the optical connector illustrated in FIG. 1.

FIG. 3 is a block diagram illustrating a control configuration of the optical connector of the present embodiment.

FIG. 4 is a partial enlarged view of an optical connector according to a second embodiment of the present disclosure.

FIG. 5 is a partial enlarged view of an optical connector according to a third embodiment of the present disclosure.

FIG. 6 is an arrow A-A sectional view of the optical connector illustrated in FIG. 5.

FIG. 7 is a partial enlarged view of an optical connector according to a fourth embodiment of the present disclosure.

### DESCRIPTION OF EMBODIMENTS

### First Embodiment

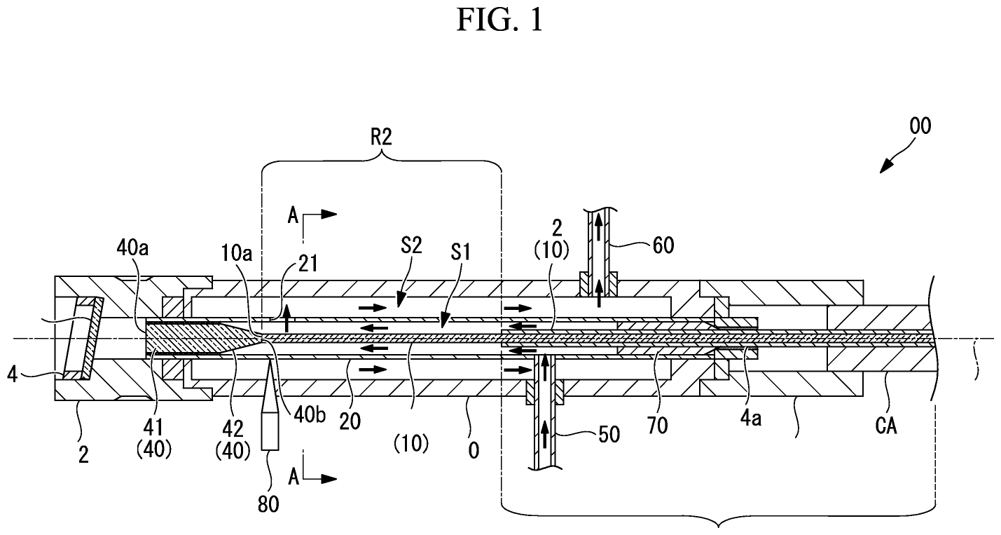

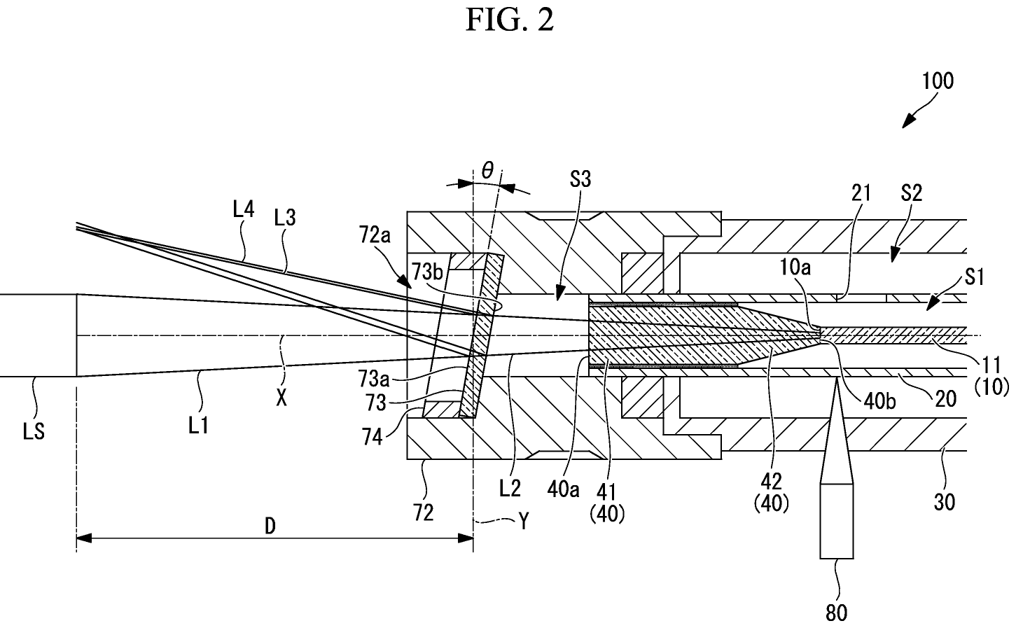

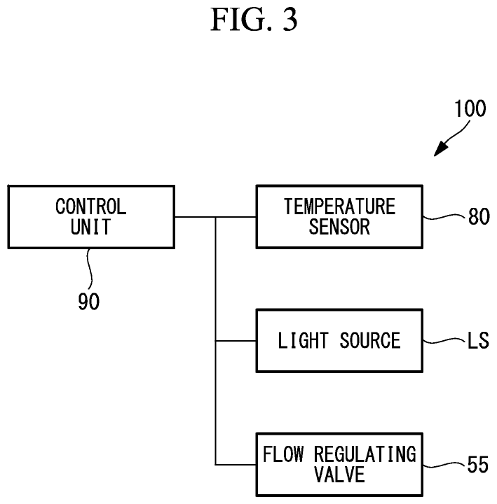

An optical connector 100 according to a first embodiment of the present disclosure will be described below with reference to the drawings. FIG. 1 is a longitudinal sectional view illustrating the optical connector 100 according to the present embodiment. FIG. 2 is a partial enlarged view of the optical connector 100 illustrated in FIG. 1. FIG. 3 is a block diagram illustrating a control configuration of the optical connector 100 according to the present embodiment. Arrows illustrated in FIG. 1 represent flow directions of a cooling medium.

The optical connector 100 of the present embodiment is a device for connecting an optical fiber 10 and a laser machining device (not illustrated) to each other when transmitting a laser beam L1, which is emitted from a light source LS, to the laser machining device through the optical fiber 10. As illustrated in FIG. 1 and FIG. 3, the optical connector 100 includes the optical fiber 10, an inner sleeve 20, an outer sleeve 30, a light guide member 40, a supply mechanism (cooling mechanism) 50, a flow regulating valve (supply rate regulating unit) 55, a discharge mechanism (cooling mechanism) 60, a holding member 70, a rear fixing sleeve 71, a front fixing sleeve (fixing mechanism) 72, a window member 73, a fixing member 74, a temperature sensor (temperature detection unit) 80, and a control unit (output adjustment unit) 90.

The optical fiber 10 is a member arranged along the axis X and configured to transmit a laser beam entering the incident end face 10a from the light source LS via the light guide member 40. The optical fiber 10 has a core part 11 configured to transmit a laser beam and having a circular cross section orthogonal to the axis X and a coating part 12 covering the outer circumferential face of the core part 11. The output of the laser beam emitted by the light source LS is preferably 1 W or higher, more preferably 1 kW or higher.

The optical fiber used herein is effective to both a solid type fiber and a hollowed photonic crystal fiber (PCF) and, in particular, significantly effective to fibers capable of transmitting high quality laser, such as high-power and single mode fiber laser.

The core part 11 is a member in which a glass clad is provided outside a glass core. The coating part 12 is formed of a UV curable resin such as polyimide. As illustrated in FIG. 1, the core part 11 is coated with the coating part 12 in a coated region R1 along the axis X. However, the core part 11 is not coated with the coating part 12 in an uncoated region R2 along the axis X.

The inner sleeve 20 is a member formed in a circular cylindrical shape along the axis X and configured to hold the optical fiber 10 on the inner circumferential side of the inner sleeve 20. The inner sleeve 20 is formed of a metal material having high thermal conductivity, such as brass. The inside of the inner sleeve 20 is an inflow space S1 into which a cooling medium such as cooling water flows through the supply mechanism 50. The inflow space S1 is a space formed annularly about the axis X.

The outer sleeve 30 is a member formed in a circular cylindrical shape along the axis X and configured to hold the inner sleeve 20 on the inner circumferential side of the outer sleeve 30. The outer sleeve 30 is formed of a copper alloy, brass, an aluminum alloy, or the like having excellent thermal conductivity. An outflow space S2 that guides a cooling medium flowing out of the discharge mechanism 60 is defined between the inner sleeve 20 and the outer sleeve 30. The outflow space S2 is a space formed annularly about the axis X.

The inner sleeve 20 has a communication hole 21 that provides communication between the inflow space S1 and the outflow space S2 in the uncoated region R2. As illustrated in FIG. 1, the communication hole 21 is formed near the position at which the incident end face 10a of the optical fiber 10 and the second end face 40b of the light guide member 40 are joined (fused) to each other. The communication hole 21 may be formed in only one portion illustrated in FIG. 1 or may be formed in multiple portions in the circumferential direction about the axis X.

The light guide member 40 is a member that guides a laser beam to the incident end face 10a of the optical fiber 10 in which this laser beam is emitted along the axis X from the light source LS. The light guide member 40 has a first end face 40a that a laser beam emitted from the light source LS enters and a second end face 40b fused and thereby joined to the incident end face 10a of the optical fiber 10. The light guide member 40 guides a laser beam from the first end face 40a to the second end face 40b.

The light guide member 40 is a member in which a first member 41 formed in a columnar shape and a second member 42 formed in a substantially cone shape are integrally formed. For example, the light guide member 40 is formed of quartz. As illustrated in FIG. 1, the outer circumferential face of the first member 41 is joined to the inner circumferential face of a front fixing sleeve 72 side (one end side) of the inner sleeve 20 via an adhesive agent.

The supply mechanism 50 is a mechanism that supplies a cooling medium to the inflow space S1 in the coated region R1. The supply mechanism 50 is a tube body that causes a cooling medium supplied from a supply source (not illustrated) via the flow regulating valve 55 to flow therethrough. The supply mechanism 50 penetrates through the outer sleeve 30 and communicates with the inflow space S1 inside the inner sleeve 20.

The flow regulating valve 55 is a valve body whose opening is adjusted in accordance with a control signal transmitted from the control unit 90. The flow regulating valve 55 guides a cooling medium from the supply source to the supply mechanism 50 at a supply rate in accordance with the opening.

The discharge mechanism 60 is a mechanism that discharges a cooling medium from the outflow space S2 to outside in the coated region R1 in which this cooling medium has flown into the inflow space S1 from the supply mechanism 50 and been guided to the outflow space S2 through the communication hole 21. The discharge mechanism is a tube body that causes a cooling medium to flow from the outflow space S2 to outside. The discharge mechanism 60 penetrates through the outer sleeve 30 and communicates with the outflow space S2.

The supply mechanism 50 and the discharge mechanism 60 have a function as a cooling mechanism that cools the optical fiber 10 and also cools the front fixing sleeve 72. That is, the cooling mechanism of the present embodiment has the supply mechanism 50 and the discharge mechanism 60. The supply mechanism 50 cools the inner sleeve 20 by the cooling medium caused to flow into the inflow space S1 and cools the front fixing sleeve 72 via the inner sleeve 20. The discharge mechanism 60 cools the outer sleeve 30 by the cooling medium caused to flow out of the outflow space S2 and cools the front fixing sleeve 72 via the outer sleeve 30.

The holding member 70 is a member formed in a columnar shape along the axis X and configured to hold the optical fiber 10. As illustrated in FIG. 1, the outer circumferential face of the holding member 70 is fixed to the inner circumferential face on a rear fixing sleeve 71 side (the other end side) of the inner sleeve 20. The holding member 70 is attached while being abutted against the rear fixing sleeve 71.

A seal material 74a made of a silicone resin, for example, is filled so as to seal a portion where the holding member 70 and the rear fixing sleeve 71 are abutted against each other. Further, as described above, the outer circumferential face of the first member 41 is joined to the inner circumferential face of the front fixing sleeve 72 side (one end side) of the inner sleeve 20 via an adhesive agent. Accordingly, the inflow space S1 is a space sealed by the light guide member 40 and the holding member 70.

The rear fixing sleeve 71 is a member attached to the end on the opposite side of the light source LS of the inner sleeve 20 and the outer sleeve 30 and formed in a circular cylindrical shape along the axis X. The inner sleeve 20 and the outer sleeve 30 are attached to the rear fixing sleeve 71 on the light source LS side. A fiber cable CA is attached to the rear fixing sleeve 71 on the opposite side of the light source LS.

The front fixing sleeve 72 is a member attached to the end on the light source LS side of the inner sleeve 20 and the outer sleeve 30 and formed in a circular cylindrical shape along the axis X. The front fixing sleeve 72 is formed of a metal material such as a copper alloy, aluminum, brass, or the like. It is preferable to use a metal material having a thermal conductivity of 50 W/mK or higher as the metal material forming the front fixing sleeve 72.

The front fixing sleeve 72 fixes the light guide member 40 and the window member 73 and defines a light guide space S3 sealed between the first end face 40a of the light guide member 40 and the second transmission face 73b of the window member 73. The front fixing sleeve 72 is attached to the end on the light source LS side of the inner sleeve 20 and the outer sleeve 30.

The window member 73 is a member arranged between the light source LS and the light guide member 40 and configured to guide a laser beam emitted from the light source LS to the first end face 40a of the light guide member 40. The window member 73 is formed of a transmissive material (for example, quartz) and arranged with the light guide space S3 being interposed and sealed between the light guide member 40 and the window member 73.

As illustrated in FIG. 2, the window member 73 has a first transmission face 73a that the laser beam L1 emitted from the light source LS enters and a second transmission face 73b that emits the laser beam L1, which has entered the first transmission face 73a, toward the light guide member 40. In FIG. 2, the axis X matches the optical axis of the laser beam L1 emitted from the light source LS.

The first transmission face 73a is arranged inclined by a predetermined angle θ relative to a plane orthogonal to the axis X. In FIG. 2, the first transmission face 73a is inclined by the predetermined angle θ relative to a plane which is orthogonal to the axis X and on which the axis Y orthogonal to the axis X is arranged. The second transmission face 73b is arranged inclined by the predetermined angle θ relative to a plane orthogonal to the axis X in the same manner as the first transmission face 73a. The window member 73 is formed such that the first transmission face 73a and the second transmission face 73b are parallel to each other.

Herein, the predetermined angle θ is set to 0.01 degrees or greater and 10 degrees or less. Further, it is preferable to set the predetermined angle θ to 0.1 degrees or greater and 10 degrees or less. Further, it is more preferable to set the predetermined angle θ to 0.1 degrees or greater and 5 degrees or less.

The laser beam L1 that has entered the first transmission face 73a of the window member 73 is emitted from the second transmission face 73b of the window member 73 and enters the first end face 40a of the light guide member 40 via the light guide space S3 as a laser beam L2. The laser beam L2 that has entered the first end face 40a is guided to the incident end face 10a of the optical fiber 10 via the second end face 40b.

A part of the laser beam L1 emitted from the light source LS is reflected by the first transmission face 73a of the window member 73. The laser beam L1 reflected by the first transmission face 73a is guided to the light source LS side as a laser beam L3. As illustrated in FIG. 2, the laser beam L3 is guided to the light source LS side but does not enter the light source LS. This is because the first transmission face 73a is arranged inclined by the predetermined angle θ relative to the plane orthogonal to the axis X. The predetermined angle θ is set so that the laser beam L3 does not enter the light source LS taking a distance D in the axis X direction from the light source LS to the first transmission face 73a or the like into consideration.

A part of the laser beam L1 emitted from the light source LS is reflected by the second transmission face 73b of the window member 73. The laser beam L1 reflected by the second transmission face 73b is guided to the light source LS side as a laser beam LA. As illustrated in FIG. 2, the laser beam L4 is guided to the light source LS side but does not enter the light source LS. This is because the second transmission face 73b is arranged inclined by the predetermined angle θ relative to the plane orthogonal to the axis X. The predetermined angle θ is set so that the laser beam L4 does not enter the light source LS taking the distance D in the axis X direction from the light source LS to the second transmission face 73b or the like into consideration.

The fixing member 74 is a member that fixes the window member 73 to the front fixing sleeve 72. The fixing member 74 fixes the window member 73 between the front fixing sleeve 72 and the fixing member 74 with the window member 73 being inserted in a recess 72a of the front fixing sleeve 72.

The temperature sensor 80 is a device that determines a temperature of a cooling medium that has passed through a boundary position between the coated region R1 and the uncoated region R2. The temperature sensor 80 determines the temperature of the inner sleeve 20 near a position at which the incident end face 10a of the optical fiber 10 and the second end face 40b of the light guide member 40 are joined (fused) to each other. By determining the temperature of the inner sleeve 20, the temperature sensor 80 can determine the temperature of the cooling medium passing through the position at which the incident end face 10a of the optical fiber 10 and the second end face 40b of the light guide member 40 are fused to each other.

The control unit 90 is a device that adjusts the flow regulating valve 55 and the output of a laser beam of the light source LS in accordance with the temperature determined by the temperature sensor 80. The control unit 90 controls the flow regulating valve 55 so as to increase the opening of the flow regulating valve 55 when the temperature determined by the temperature sensor 80 is higher than a target temperature. Further, the control unit 90 controls the flow regulating valve 55 so as to reduce the opening of the flow regulating valve 55 when the temperature determined by the temperature sensor 80 is lower than a target temperature.

The control unit 90 adjusts the light source LS so as to stop the output of the laser beam output from the light source LS when the temperature determined by the temperature sensor 80 is higher than a predetermined threshold temperature. By stopping the output of the laser beam, it is possible to prevent the optical connector 100 from being maintained at a temperature higher than the threshold temperature and damaged.

Next, the flow of the cooling medium flowing through inside of the optical connector 100 of the present embodiment will be described.

The cooling medium supplied from the supply source is supplied to the inflow space S1 of the coated region R1 through the supply mechanism 50 with the supply rate being regulated by the flow regulating valve 55. The cooling medium supplied to the inflow space S1 of the coated region R1 flows through along the axis X from the coated region R1 toward the uncoated region R2 and passes through the boundary position between the coated region R1 and the uncoated region R2. The cooling medium passing through the boundary position cools the coating part 12 near the boundary position.

The cooling medium that has passed through the boundary position flows through along the axis X toward the light guide member 40 and is guided from the communication hole 21 to the outflow space S2 of the uncoated region R2. The cooling medium that has flown through the inflow space S1 from the coated region R1 toward the uncoated region R2 turns back at the communication hole 21 and flows through the outflow space S2 in the reverse direction from the uncoated region R2 to the coated region R1. The cooling medium that has passed through the boundary position between the uncoated region R2 and the coated region R1 is discharged from the outflow space S2 to outside through the discharge mechanism 60.

Since the inner sleeve 20 and the outer sleeve 30 are cooled by the cooling medium, the front fixing sleeve 72 in contact with the inner sleeve 20 and the outer sleeve 30 is cooled. When the front fixing sleeve 72 is cooled, the window member 73 arranged in contact with the front fixing sleeve 72 is cooled.

The optical connector 100 of the present embodiment described above achieves the following effects and advantages.

According to the optical connector 100 of the present embodiment, the laser beam L1 emitted from the light source LS enters the first transmission face 73a of the window member 73, is emitted from the second transmission face 73b, and is guided to the light guide member 40. The laser beam L2 that has entered the first end face 40a of the light guide member 40 is guided from the second end face 40b to the incident end face 10a of the optical fiber 10. The first transmission face 73a of the window member 73 that the laser beam L1 enters is arranged inclined by a predetermined angle θ relative to a plane orthogonal to the axis X, which is the optical axis of the laser beam L1.

Thus, although a part of the laser beam L1 entering the window member 73 is reflected by the first transmission face 73a, the reflected laser beam L1 is guided in a direction inclined by the predetermined angle θ relative to the axis X. This prevents the reflected laser beam L1 from being guided along the axis X to the light source LS to cause damage to the laser oscillator or the optical fiber of the light source LS.

Further, according to the optical connector 100 of the present embodiment, because the predetermined angle θ, which is an inclination angle relative to the plane orthogonal to the axis X of the first transmission face 73a of the window member 73 that the laser beam L1 enters, is set to 0.01 degrees or greater and 10 degrees or less, it is possible to suitably prevent the laser beam L1 reflected by the first transmission face 73a from being guided to the light source LS along the axis X.

Further, according to the optical connector 100 of the present embodiment, since the light guide space S3 is arranged between the window member 73 and the light guide member 40, the energy density of a laser beam transmitting through the window member 73 is lower than that in a case where the light guide space S3 is not arranged, and this can suppress the window member 73 from being heated. Further, since the light guide space S3 is sealed, this can suppress dust from adhering to the light guide member 40 and suppress a failure due to burning of dust adhered to the light guide member 40 or the like.

Further, according to the optical connector 100 of the present embodiment, the cooling medium supplied to the inflow space S1 inside the inner sleeve 20 is guided from the communication hole 21 to the outflow space S2 and guided from the outflow space S2 to outside through the discharge mechanism 60. Since the front fixing sleeve 72 is cooled by the cooling medium flowing through the inflow space S1 and the outflow space S2, it is possible to cool the window member 73 via the front fixing sleeve 72 and prevent occurrence of a thermal lens effect due to the window member 73 being heated.

Occurrence of a thermal lens effect would undesirably change a focal position of the laser beam L2 and increase the beam diameter of the laser beam L2 on the incident end face 10a of the optical fiber 10. If the beam diameter of the laser beam L2 increased to be larger than the incident end face 10a of the optical fiber 10, the laser beam L2 which does not enter the optical fiber 10 could cause damage to components of the optical connector 100.

### Second Embodiment

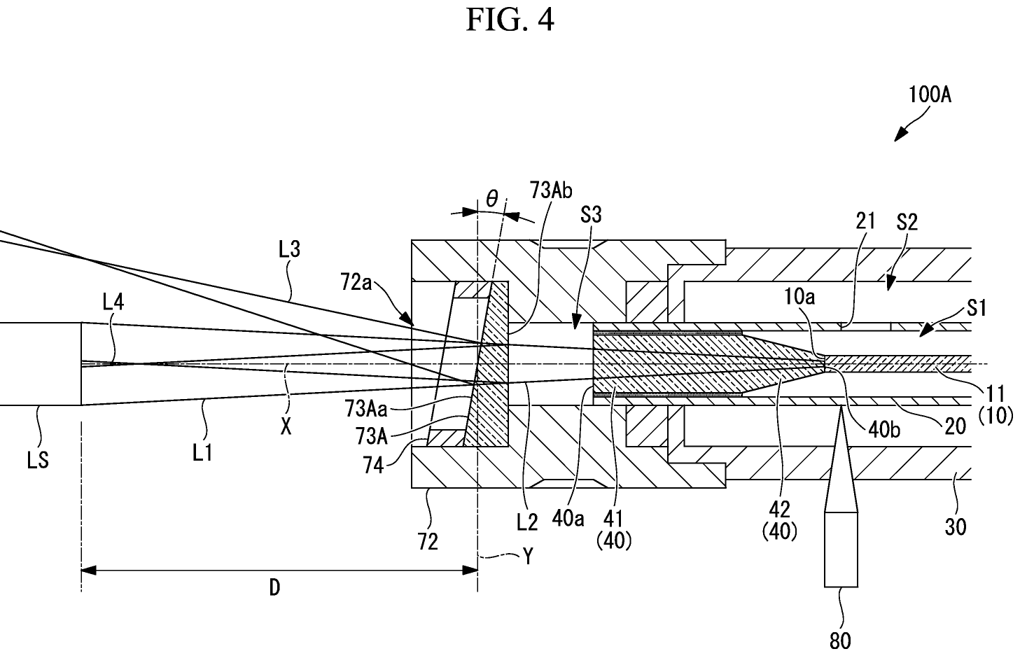

An optical connector 100A according to a second embodiment of the present disclosure will be described below with reference to the drawings. The second embodiment is a modified example to the first embodiment and is intended to be the same as the first embodiment unless otherwise stated below, and the description thereof will be omitted in the following. FIG. 4 is a partial enlarged view of the optical connector 100A according to the present embodiment.

The window member 73 of the first embodiment is provided such that both the first transmission face 73a and the second transmission face 73b are arranged inclined by the predetermined angle θ relative to the plane orthogonal to the axis X. In contrast, a window member 73A of the present embodiment is provided such that a first transmission face 73Aa is arranged inclined by the predetermined angle θ relative to the plane orthogonal to the axis X and a second transmission face 73Ab is arranged orthogonal to the axis X.

As illustrated in FIG. 4, the window member 73A is a member arranged between the light source LS and the light guide member 40 and configured to guide a laser beam emitted from the light source LS to the first end face 40a of the light guide member 40. The window member 73A is formed of a transmissive material (for example, quartz) and arranged with the light guide space S3 being interposed and sealed between the light guide member 40 and the window member 73A.

As illustrated in FIG. 4, the window member 73A has a first transmission face 73Aa that the laser beam L1 emitted from the light source LS enters and a second transmission face 73Ab that emits the laser beam L1, which has entered the first transmission face 73Aa, toward the light guide member 40. In FIG. 4, the axis X matches the optical axis of the laser beam L1 emitted from the light source LS.

The first transmission face 73Aa is arranged inclined by a predetermined angle θ relative to a plane orthogonal to the axis X. In FIG. 4, the first transmission face 73Aa is inclined by the predetermined angle θ relative to a plane which is orthogonal to the axis X and on which the axis Y orthogonal to the axis X is arranged. The second transmission face 73Ab is arranged orthogonal to the axis X.

Herein, the predetermined angle θ is set to 0.01 degrees or greater and 10 degrees or less. Further, it is preferable to set the predetermined angle θ to 0.1 degrees or greater and 10 degrees or less. Further, it is more preferable to set the predetermined angle θ to 0.1 degrees or greater and 5 degrees or less.

The laser beam L1 that has entered the first transmission face 73Aa of the window member 73A is emitted from the second transmission face 73Ab of the window member 73A and enters the first end face 40a of the light guide member 40 via the light guide space S3 as a laser beam L2. The laser beam L2 that has entered the first end face 40a is guided to the incident end face 10a of the optical fiber 10 via the second end face 40b.

A part of the laser beam L1 emitted from the light source LS is reflected by the first transmission face 73Aa of the window member 73A. The laser beam L1 reflected by the first transmission face 73Aa is guided to the light source LS side as a laser beam L3. As illustrated in FIG. 4, the laser beam L3 is guided to the light source LS side but does not enter the light source LS. This is because the first transmission face 73Aa is arranged inclined by the predetermined angle θ relative to the plane orthogonal to the axis X. The predetermined angle θ is set so that the laser beam L3 does not enter the light source LS taking the distance D in the axis X direction from the light source LS to the first transmission face 73Aa or the like into consideration.

A part of the laser beam L1 emitted from the light source LS is reflected by the second transmission face 73Ab of the window member 73A. The laser beam L1 reflected by the second transmission face 73Ab is guided to the light source LS side as a laser beam L4. As illustrated in FIG. 4, the laser beam L4 is guided along the axis X in a direction of incidence on the light source LS.

Although the laser beam L1 reflected by the second transmission face 73Ab is guided to the light source LS as the laser beam LA, the laser beam L1 reflected by the first transmission face 73Aa does not enter the light source LS. Therefore, according to the window member 73A of the present embodiment, the light amount of the laser beam reflected by the window member 73 and guided to the light source LS can be reduced compared to a case where both the laser beam reflected by the first transmission face 73Aa and the laser beam reflected by the second transmission face 73Ab are guided to the light source LS.

### Third Embodiment

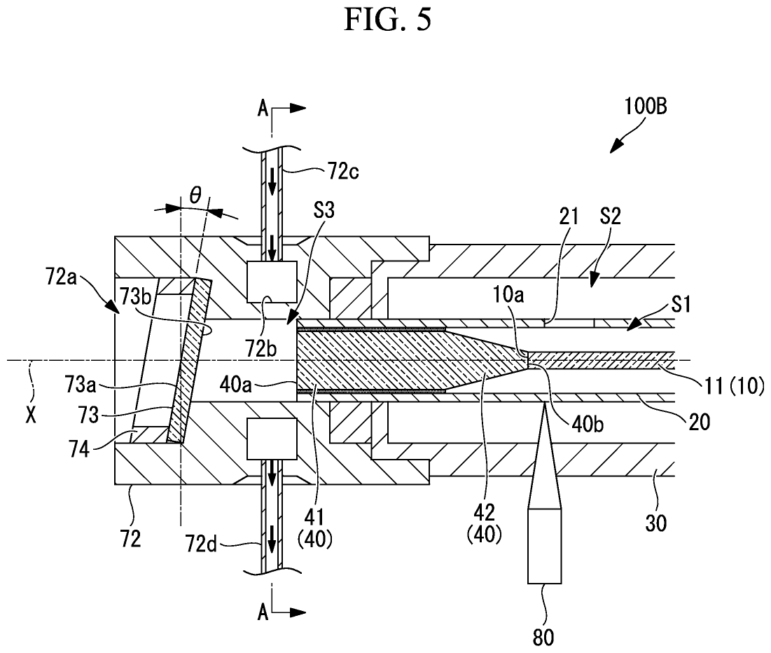

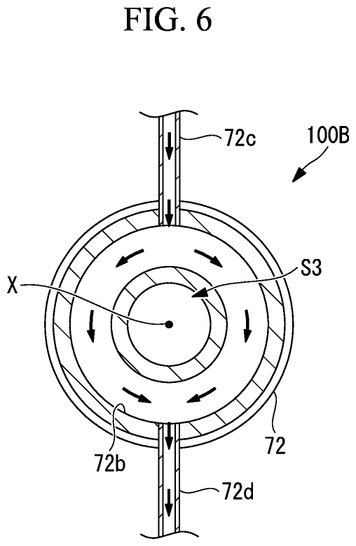

An optical connector 100B according to a third embodiment of the present disclosure will be described below with reference to the drawings. The third embodiment is a modified example to the first embodiment and is intended to be the same as the first embodiment unless otherwise stated below, and the description thereof will be omitted in the following. FIG. 5 is a partial enlarged view of the optical connector 100B according to the present embodiment. FIG. 6 is an arrow A-A sectional view of the optical connector 100B illustrated in FIG. 5.

The optical connector 100 of the first embodiment is provided such that the front fixing sleeve 72 is indirectly cooled by the cooling mechanism having the supply mechanism 50 and the discharge mechanism 60. In contrast, the optical connector 100B of the present embodiment includes a cooling mechanism that, in addition to indirectly cooling the front fixing sleeve 72, causes a cooling medium to flow through a cooling medium flow path 72b, which is further formed inside the front fixing sleeve 72, to directly cool the front fixing sleeve 72.

As illustrated in FIG. 5, in the optical connector 100B of the present embodiment, the cooling medium flow path 72b through which a cooling medium (for example, water) flows is formed inside the front fixing sleeve 72. As illustrated in FIG. 6, the cooling medium flow path 72b is a flow path formed annularly in the circumferential direction about the axis X inside the front fixing sleeve 72.

The cooling medium flow path 72b is supplied with a cooling medium guided from a cooling medium supply source (not illustrated) via the supply mechanism 72c. The cooling medium supplied to the cooling medium flow path 72b flows through in directions indicated by arrows in FIG. 6 and is discharged to outside through the discharge mechanism 72d. In the present embodiment, the cooling medium flow path 72b functions as a cooling mechanism that cools the front fixing sleeve 72.

According to the optical connector 100B of the present embodiment, by causing a cooling medium to flow through the cooling medium flow path 72b formed inside the front fixing sleeve 72, it is possible to cool the window member 73 via the front fixing sleeve 72 and prevent a thermal lens effect from occurring due to the window member 73 being heated.

### Fourth Embodiment

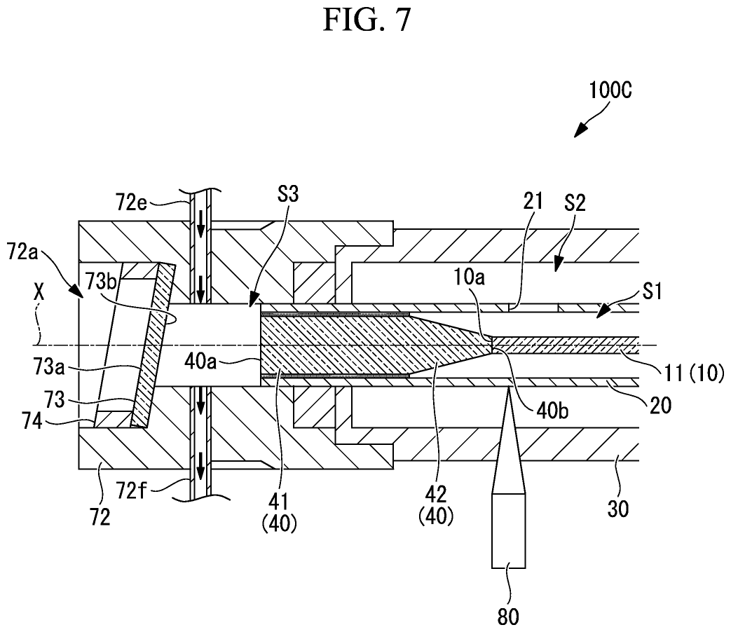

An optical connector 100C according to a fourth embodiment of the present disclosure will be described below with reference to the drawings. The fourth embodiment is a modified example to the first embodiment and is intended to be the same as the first embodiment unless otherwise stated below, and the description thereof will be omitted in the following. FIG. 7 is a partial enlarged view of the optical connector 100C according to the present embodiment.

The optical connector 100 of the first embodiment is provided such that the front fixing sleeve 72 is indirectly cooled by the cooling mechanism having the supply mechanism 50 and the discharge mechanism 60. In contrast, the optical connector 100C of the present embodiment includes a cooling mechanism that causes a gas-phase cooling medium to flow through the light guide space S3, which is further formed inside the front fixing sleeve 72, to directly cool the window member 73 in addition to indirectly cooling the front fixing sleeve 72.

As illustrated in FIG. 7, the front fixing sleeve 72 of the optical connector 100C of the present embodiment has a supply pipe 72e configured to supply a gas-phase cooling medium to the light guide space S3 of the front fixing sleeve 72 and a discharge pipe 72f configured to externally discharge a cooling medium supplied to the light guide space S3. In the present embodiment, the supply pipe 72e and the discharge pipe 72f function as a cooling mechanism that causes a gas-phase refrigerant to flow through the light guide space S3.

According to the optical connector 100C of the present embodiment, it is possible to directly cool the window member 73 by causing a gas-phase cooling medium to flow through the light guide space S3 and prevent a thermal lens effect from occurring due to the window member 73 being heated.

The optical connectors according to the present embodiments described above are understood as follows, for example.

The optical connector (100) according to the present disclosure includes: an optical fiber (10) arranged along an axis (X); a light guide member (40) having a first end face (40a) and a second end face (40b) and configured to guide a laser beam from the first end face to the second end face, the laser beam emitted along the axis from a light source (LS) entering the first end face, and the second end face being joined to an incident end face (10a) of the optical fiber; and a window member (73) arranged between the light source and the light guide member and configured to guide, to the first end face (40a) of the light guide member, the laser beam emitted from the light source. The window member has a first transmission face (73a) and a second transmission face (73b), the laser beam emitted from the light source entering the first transmission face, and the second transmission face being configured to emit the laser beam entering the first transmission face to the light guide member, and the first transmission face is arranged inclined by a predetermined angle (0) relative to a plane orthogonal to the axis.

According to the optical connector of the present disclosure, a laser beam emitted from the light source enters the first transmission face of the window member, is emitted from the second transmission face, and is guided to the light guide member. The laser beam that has entered the first end face of the light guide member is guided from the second end face to the incident end face of the optical fiber. The first transmission face of the window member that the laser beam enters is arranged inclined by a predetermined angle relative to a plane orthogonal to the axis, which is the optical axis of the laser beam.

Thus, while a part of the laser beam entering the window member is reflected by the first transmission face, the reflected laser beam is guided in the direction inclined by a predetermined angle relative to the axis. This prevents the reflected laser beam from being guided along the axis to the light source to cause damage to the laser oscillator or the optical fiber of the light source.

The optical connector according to the present disclosure may be configured such that the predetermined angle is set to 0.01 degrees or greater and 10 degrees or less. The predetermined angle is more preferably 0.1 degrees of greater and 10 degrees or less, much more preferably 0.1 degrees of greater and 5 degrees or less.

Because the inclination angle relative to the plane orthogonal to the axis of the first transmission face of the window member that the laser beam enters is set to 0.01 degrees or greater and 10 degrees or less, it is possible to suitably prevent a laser beam reflected by the first transmission face from being guided to the light source along the axis.

The optical connector according to the present disclosure may be configured such that the window member is arranged with a light guide space (S3) being interposed and sealed between the light guide member and the window member.

According to the optical connector of the present configuration, since the light guide space is arranged between the window member and the light guide member, the energy density of a laser beam transmitting through the window member is lower than that in a case where the light guide space is not arranged, and this can suppress the window member from being heated. Further, since the light guide space is sealed, this can suppress dust from adhering to the light guide member and suppress a failure due to burning of dust adhered to the light guide member or the like.

The optical connector according to the present disclosure may be configured to include: a fixing mechanism (72) configured to fix the light guide member and the window member and define the light guide space; and a cooling mechanism (50, 60) configured to cool the fixing mechanism.

According to the optical connector of the present configuration, the fixing mechanism is cooled by the cooling mechanism, and thereby the window member fixed to the fixing mechanism can be cooled. It is thus possible to prevent a thermal lens effect from occurring due to the window member being heated.

Occurrence of a thermal lens effect would undesirably change a focal position of the laser beam and increase the beam diameter of the laser beam on the incident end face of the optical fiber. If the beam diameter of the laser beam increased to be larger than the incident end face of the optical fiber, the laser beam which does not enter the optical fiber could cause damage to components of the optical connector.

The optical connector according to the above configuration may be configured to include an inner sleeve (20) formed in a circular cylindrical shape along the axis and configured to hold the optical fiber on the inner circumferential side of the inner sleeve, and an outer sleeve (30) formed in a circular cylindrical shape along the axis and configured to hold the inner sleeve on the inner circumferential side of the outer sleeve, and may be configured such that the cooling mechanism has a supply mechanism (50) configured to supply a cooling medium to an inflow space (S1) inside the inner sleeve and a discharge mechanism (60) configured to discharge the cooling medium out of an outflow space (S2) between the inner sleeve and the outer sleeve, the fixing mechanism is attached to end on the light source side of the inner sleeve and the outer sleeve, and the inner sleeve has a communication hole (21) configured to provide communication between the inflow space and the outflow space.

According to the optical connector of the present configuration, the optical fiber is held on the inner circumferential side of the inner sleeve, and the inner sleeve is held on the inner circumferential side of the outer sleeve. The cooling medium supplied to the inflow space inside the inner sleeve is guided to the outflow space via the communication hole and guided from the outflow space to outside through the discharge mechanism. Since the fixing mechanism is cooled by the cooling medium flowing through the inflow space and the outflow space, it is possible to cool the window member via the fixing mechanism and prevent a thermal lens effect from occurring due to the window member being heated.

The optical connector according to the above configuration may be configured such that the cooling mechanism is a mechanism configured to cause a cooling medium to flow through a cooling medium flow path (72b) formed inside the fixing mechanism.

According to the optical connector of the present configuration, by causing a cooling medium to flow through the cooling medium flow path formed inside the fixing mechanism, it is possible to cool the window member via the fixing mechanism and prevent a thermal lens effect from occurring due to the window member being heated.

The optical connector according to the above configuration may be configured such that the cooling mechanism is a mechanism configured to cause a gas-phase cooling medium to flow through the light guide space.

According to the optical connector of the present configuration, it is possible to cause a gas-phase cooling medium to flow through the light guide space to cool the window member and prevent a thermal lens effect from occurring due to the window member being heated.

### REFERENCE SIGNS LIST

10 optical fiber
10a incident end face
11 core part
12 coating part
20 inner sleeve
21 communication hole
30 outer sleeve
40 light guide member
40a first end face
40b second end face
41 first member
42 second member
50 supply mechanism (cooling mechanism)
55 flow regulating valve
60 discharge mechanism (cooling mechanism)
70 holding member
71 rear fixing sleeve
72 front fixing sleeve (fixing mechanism)
72b cooling medium flow path (cooling mechanism)
72c supply mechanism (cooling mechanism)
72d discharge mechanism (cooling mechanism)
72e supply pipe (cooling mechanism)
72f discharge pipe (cooling mechanism)
73, 73A window member
73a, 73Aa first transmission face
73b, 73Ab second transmission face
74 fixing member
74 seal material
80 temperature sensor
90 control unit
100, 100A, 100B, 100C optical connector
D distance
L1, L2, L3, L4 laser beam
LS light source
R1 coated region
R2 uncoated region
S1 inflow space
S2 outflow space
S3 light guide space
X axis
Y axis
θ predetermined angle

1. An optical connector comprising:
an optical fiber arranged along an optical axis;
a light guide member having a first end face and a second end face and configured to guide a laser beam from the first end face to the second end face, the laser beam emitted along the optical axis from a light source entering the first end face, and the second end face being joined to an incident end face of the optical fiber; and
a window member arranged between the light source and the light guide member and configured to guide, to the first end face of the light guide member, the laser beam emitted from the light source,
wherein the window member has a first transmission face and a second transmission face, the laser beam emitted from the light source entering the first transmission face, and the second transmission face being configured to emit the laser beam entering the first transmission face to the light guide member, and
wherein the first transmission face is arranged inclined by a predetermined angle relative to a plane orthogonal to the optical axis.

2. The optical connector according to claim 1,
wherein the predetermined angle is set to 0.01 degrees or greater and 10 degrees or less.

3. The optical connector according to claim 1,
wherein the window member is arranged with a light guide space being interposed and sealed between the light guide member and the window member.

4. The optical connector according to claim 3 further comprising:
a fixing mechanism configured to fix the light guide member and the window member and define the light guide space; and
a cooling mechanism configured to cool the fixing mechanism.

5. The optical connector according to claim 4 further comprising:
an inner sleeve formed in a circular cylindrical shape along the optical axis and configured to hold the optical fiber on the inner circumferential side of the inner sleeve; and
an outer sleeve formed in a circular cylindrical shape along the optical axis and configured to hold the inner sleeve on the inner circumferential side of the outer sleeve,
wherein the cooling mechanism has
a supply mechanism configured to supply a cooling medium to an inflow space inside the inner sleeve, and
a discharge mechanism configured to discharge the cooling medium out of an outflow space between the inner sleeve and the outer sleeve,
wherein the fixing mechanism is attached to ends of the inner sleeve and the outer sleeve on the light source side, and
wherein the inner sleeve has a communication hole configured to provide communication between the inflow space and the outflow space.

6. The optical connector according to claim 4,
wherein the cooling mechanism is a mechanism configured to cause a cooling medium to flow through a cooling medium flow path formed inside the fixing mechanism.

7. The optical connector according to claim 4,
wherein the cooling mechanism is a mechanism configured to cause a gas-phase cooling medium to flow through the light guide space.

8. The optical connector according to claim 1,
wherein the second transmission face is arranged orthogonal to the optical axis.
